(19) United States
(12) Patent Application Publication
(10) Pub. No.: US 2025/0367546 A1
(43) Pub. Date: Dec. 4, 2025

(54) DIGITAL FORMAT FOR TRANSMITTING CHANGES IN TEXTURE, TEMPERATURE, AND OTHER HAPTICS

(71) Applicant: Sony Interactive Entertainment Inc., Tokyo (JP)

(72) Inventors: Jonathan Urbanus, San Mateo, CA (US); Warren M. Benedetto, San Mateo, CA (US); Jackqueline Nguyen, San Mateo, CA (US)

(21) Appl. No.: 18/677,708

(22) Filed: May 29, 2024

(51) Int. Cl. A63F 13/285

(52) U.S. Cl. CPC A63F 13/285

(57) ABSTRACT

A computer simulation controller changes the texture of its surface dynamically over time. Textures may include bumpy, rough, spiky, smooth, rippled, etc. according to received data that not only conveys the textures themselves, but also the location of the textures on the surface of the controller. Similarly, different areas of the controller can change to different temperatures according to received data that not only indicates the temperatures but also their spatial dependency on the controller. Information regarding these two haptics may be combined in a single data structure, with texture and temperature both being expressed at the same time, with changes over time.

### FIELD

The present application relates generally to digital formats for transmitting changes in texture, temperature, and other haptics.

### BACKGROUND

Computer simulations such as computer games typically are controlled by one or more players manipulating computer simulation controllers such as computer game controllers such as a PlayStation® controller. Some controllers are equipped with vibration motors to provide haptic feedback to players, allowing them to immerse themselves even further into the video game world.

### SUMMARY

Present principles understand that haptic feedback may be further enhanced by providing texture and temperature changes on a game controller. As recognized herein, texture and temperature haptics have a spatial component that current vibration-based haptics do not. A time component also may be implicated, and as understood by present principles a data structure to convey both texture and texture changes on a controller as well as their spatial dependency on the controller is required.

Accordingly, a controller changes the texture of its surface dynamically over time. Textures may include bumpy, rough, spiky, smooth, rippled, etc. according to received data that not only conveys the textures themselves, but also the location of the textures on the surface of the controller. Similarly, different areas of the controller can change to different temperatures according to received data that not only indicates the temperatures but also their spatial dependency on the controller. Information regarding these two haptics may be combined in a single data structure, with texture and temperature both being expressed at the same time, with changes over time.

In an aspect, a method includes receiving, at a device, a data structure that includes spatially-dependent texture information. The method includes changing a texture of a first surface of the device according to the spatially-dependent texture information such that the first surface has a first texture and a second surface of the device has a second texture at a first time.

In some embodiments the data structure also includes spatially-dependent temperature information. In such embodiments the method may include changing a temperature of the first surface of the device according to the spatially-dependent temperature information such that the first surface has a first temperature and a second surface of the device has a second temperature at the first time.

In some implementations the data structure includes spatially-dependent hardness information, and the method may include changing a hardness of the first surface of the device according to the spatially-dependent hardness information such that the first surface has a first hardness and a second surface of the device has a second hardness at the first time.

In an illustrative embodiment the device includes a computer game controller.

In an example, the data structure includes a three dimensional (3D) displacement map. Embodiments of the 3D displacement map include voxels representing texture information and a heat map associated with the voxels and representing temperature information. Also, the 3D displacement map can include, for at least some of the voxels, respective indices representing hardness. Optionally, the method can include providing time-varying texture information to the device in combination with the data structure comprising spatially-dependent texture information.

In another aspect, a processor system is configured to access three dimensional (3D) model data of an object from a computer simulation. The 3D model data represents a geometry. The processor system is configured to translate the geometry into texture and temperature profiles, and provide the profiles to at least one computer simulation system for implementing the profiles on at least one computer simulation controller responsive to a player interacting with the object in the computer simulation.

In another aspect, a device includes at least one computer memory that is not a transitory signal and that in turn includes instructions executable by at least one processor system to receive spatially-dependent texture information, and implement the spatially-dependent texture information on a surface of at least one computer simulation controller during play of a computer simulation using the computer simulation controller.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example computer simulation controller embodied as a computer game controller, schematically showing haptics elements;

FIG. 3 illustrates a schematic plan view of an example texture actuator layout;

FIG. 4 illustrates a schematic side view of an example texture actuator layout;

FIG. 5 illustrates a schematic plan view of an example temperature actuator layout;

FIG. 6 illustrates example logic in example flow chart format for generating a data structure for conveying haptics information consistent with present principles;

FIG. 7 illustrates example logic in example flow chart format for using the data structure from FIG. 6 to implement haptics on a device such as but not limited to the controller shown in FIG. 2;

FIG. 8 schematically illustrates an example data structure configured as a displacement map for conveying haptics information including spatially-dependent texture and temperature data;

FIG. 9 schematically illustrates another example data structure configured as a displacement map for conveying haptics information;

FIGS. 10 and 11 illustrate example logic in example flow chart format for conveying and implementing time dependency of haptics on a controller;

FIG. 12 illustrates example end-to-end logic in example flow chart format consistent with present principles;

FIG. 13 illustrates example logic in example flow chart format for dynamic variation of temperature haptics;

FIG. 14 schematically illustrates a timeline interface for sending key frames of haptics information;

FIG. 15 schematically illustrates an example user interface (UI) for effecting a time and temperature editor developer tool;

FIG. 16 schematically illustrates a further example developer tool;

FIG. 17 illustrates an example UI for calibrating haptics based on player feedback; and

FIG. 18 illustrates example logic in example flow chart format consistent with FIG. 17.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

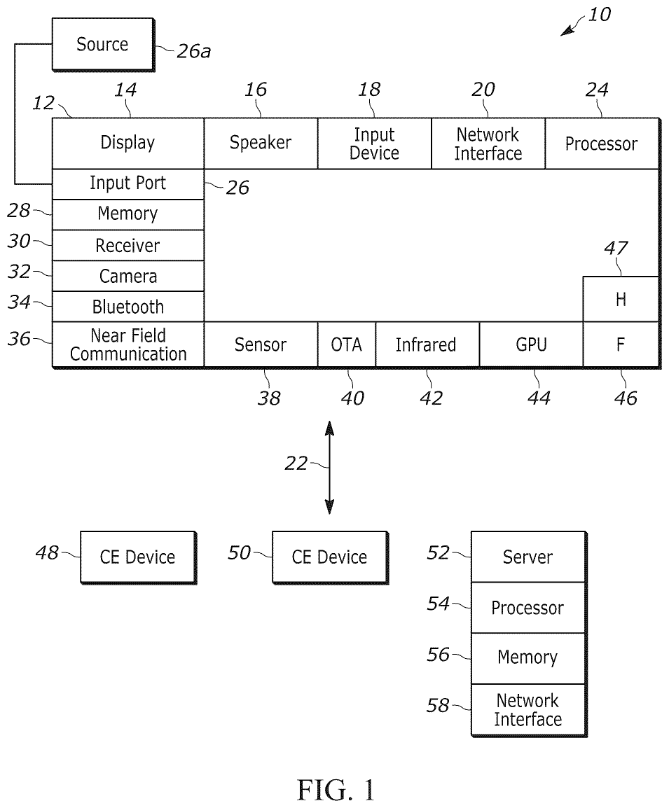

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

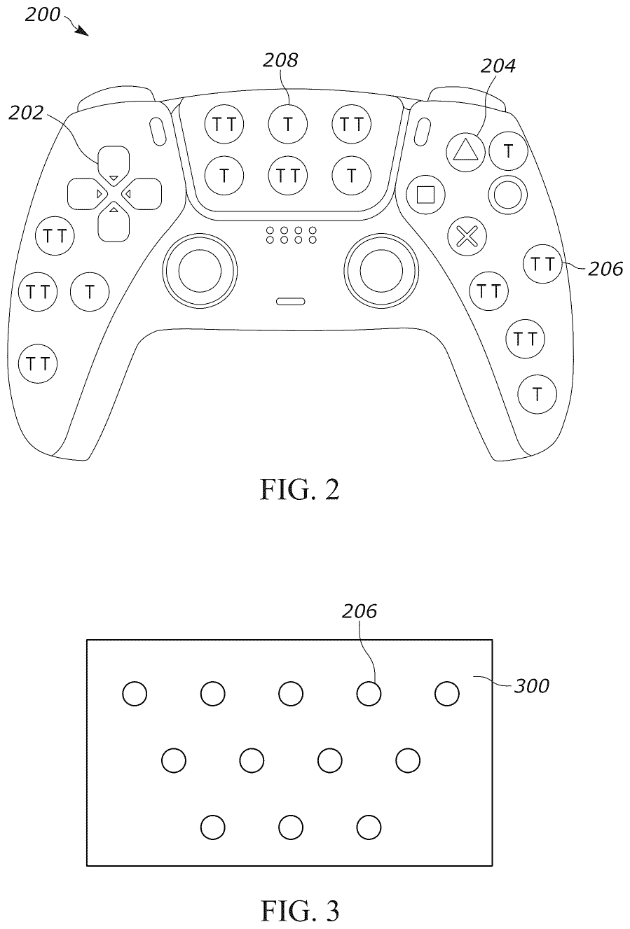

Refer now to FIG. 2. A computer simulation controller such as a computer game controller 200 is shown as one example of a device on which present techniques ma be used to implement spatially-dependent (relative to the device) haptics including texture and temperature haptics. The example controller 200 may be implemented as a PlayStation controller with navigation keys 202 and triangle, square, circle, and “X” keys 204. Additional control elements may be provided.

As schematically shown in FIG. 2, plural texture actuators 206 (labeled “TT” in FIG. 2) may be arranged on the controller. The texture actuators 206 may be actuated to produce tactile sensations of spatially-differing textures of the controller 200 to a person holding the controller. Also, plural temperature actuators 208 (labeled “T” in FIG. 2) may be arranged on the controller. The temperature actuators 208 may be actuated to produce tactile sensations of spatially-differing temperatures of the controller 200 to a person holding the controller.

The temperature actuators 208 may be implemented by respective micro Peltier coolers in the handgrips or other portion of the controller 200. On the other hand, the texture actuators 206 may be implemented by small vertically-reciprocating pins in array on a pin board, and may be arranged in the handgrips of the controller or other surface thereof.

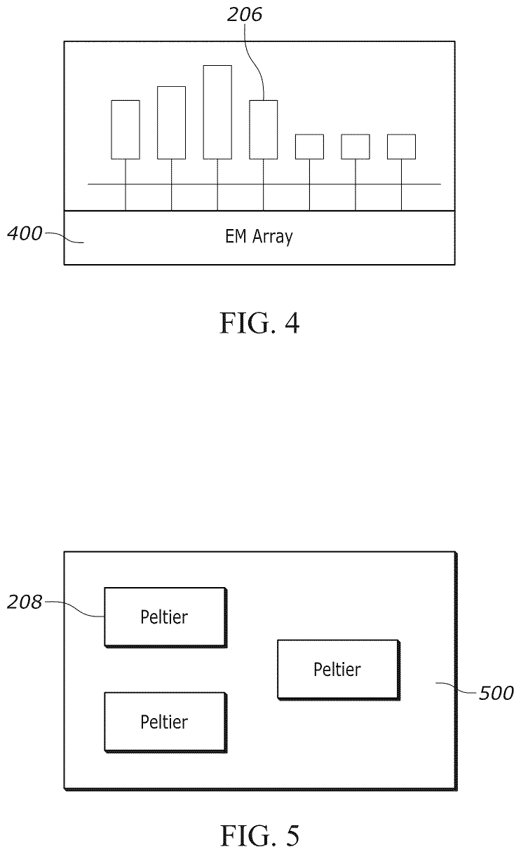

FIG. 3 illustrates further. An array of pin-shaped texture actuators 206 is arranged on a preferably flexible or shape-molded pin board 300 that may be mounted on the controller 200. As shown in FIG. 4, each pin may be moved up and down by a respective electromagnet in an array 400 of electromagnets and may be moved independently of other pins such that the perceived texture of the controller can vary from one location on the controller to another to implement a spatially-varying texture field.

Thus, the controller 200 may change the texture of its surface dynamically over time. Textures may include bumpy, rough, spiky, smooth, rippled, etc. Information to do this is conveyed to the controller in the form of the desired textures themselves (e.g., desired height to which each texture actuator should be moved to), but also the location of these textures on the surface of the controller.

Similarly, FIG. 5 illustrates that the temperature actuators 208, for instance implemented by Peltier coolers, may be arranged on a substrate 500 and may be individually actuated to produce a perceived temperature of the controller can vary from one location on the controller to another to implement a spatially-varying temperature field.

Thus, the controller is not simply configured to be hot or cold but to establish different temperatures over the surface of the controller. For example, the portion of a controller nearer to a heat source being displayed in a computer may be hotter than other portions. Or, a “cool breeze” in the game can be emulated by propagating cooler temperatures from one side of the controller to the other over time, e.g., to indicate that there is an exit from a cave in the direction from which the breeze is blowing.

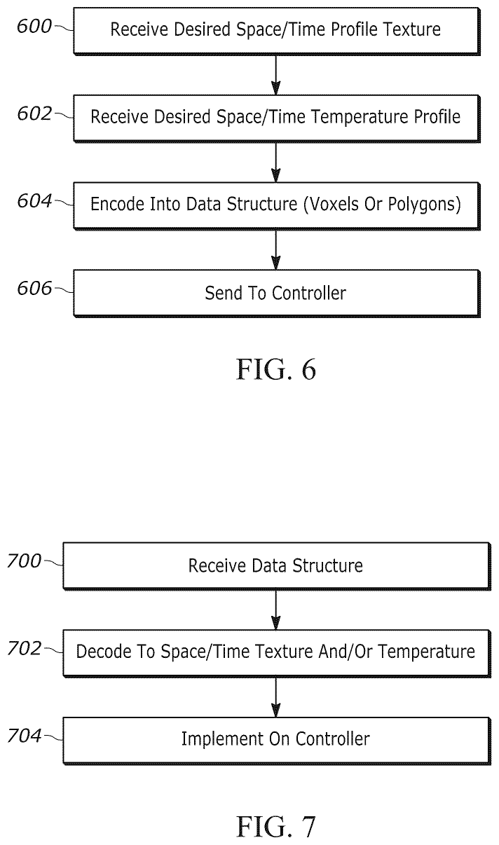

Turn now to FIG. 6, which illustrates how the plural haptics signals may be combined in a data structure provided to the controller, with texture and temperature both being expressed at the same time, with changes over time if desired. For example, a spiky, cold texture may indicate ice formations, which then changes texture to a rippling, warm texture as the ice “melts” in the player's hands.

Commencing at state 600, a desired spatially-dependent profile of texture is received. If desired, the profile also may be time-dependent. Moving to state 602, a desired spatially-dependent profile of temperature is received. If desired, the profile also may be time-dependent.

Proceeding to state 604, the profiles are encoded into a data structure. In one example, the data structure may include voxels which infer spatial dependencies of texture/temperature changes. In other examples, particularly for simpler profiles, the data structure may include polygons, which directly encode positions of texture and temperature points as vertices of the polygons. State 606 indicates that the data structure is provided to the controller, such as with game data as it is being streamed or accessed by the processor of the controller or associated game console or before game play begins for storage locally at the controller or console.

FIG. 7 illustrates that the data structure from FIG. 6 may be accessed or identified by the processor of the controller during game play at state 700, which decodes the haptics information at state 702 to implement the spatially-varying temperature and texture haptics on the controller during game play at state 704.

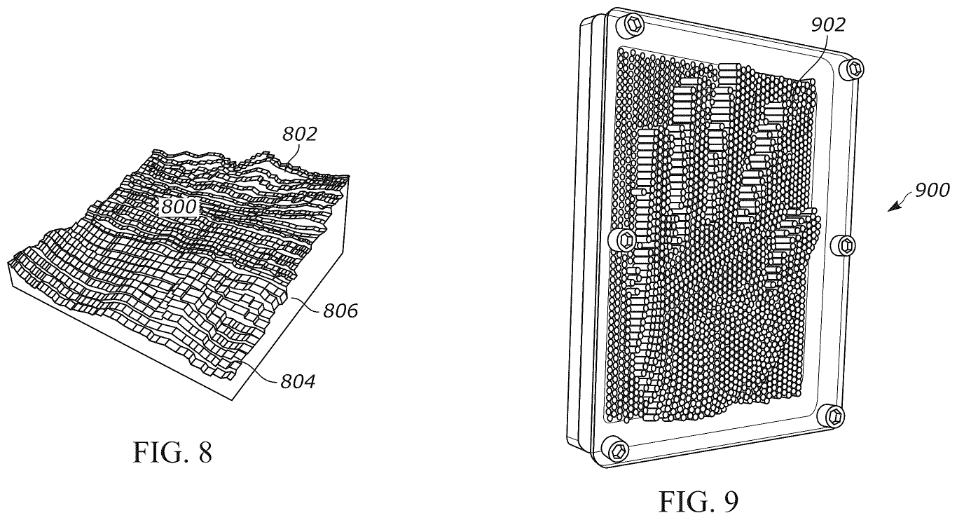

FIG. 8 illustrates an example data format for encoding texture and temperature mapped to a physical space over time. The example data format of FIG. 8 includes a 3D displacement map 800 indicating texture variations (e.g., pin heights by location) combined with a heat map indicating temperature variations by locations using color-coding (equivalently, numerals indicating relative temperatures). FIG. 8 illustrates hotter regions 802, which may be color-coded red, cooler regions 804, which may be color-coded blue, and moderate regions 806, which may be color-coded green. It is to be understood that finer-grained temperature indications are contemplated and that FIG. 8 is simplified for exposition.

The displacement map 800 in the example shown is composed of individual voxels, each of which has its own height and position. The density of the voxels in the displacement map 800 affects how specific the textures sent to the controller are to be. Higher voxel density allows more fine-grained textures.

The height of each voxel can be adjusted to communicate the desired texture to the controller. For example, a field of voxels with zero height is decoded to mean to a completely smooth texture. A field of voxels that follows a gentle sinusoidal pattern translates to a rippled texture. A field of voxels with high-amplitude spikes translates to a rough texture.

This voxel data is then combined with colored heatmap data. As discussed above, in an example embodiment a blue color indicates the coldest temperature and a red color indicates the hottest temperature, with gradients in between indicating intermediate temperature variances. This combination when implemented by the controller processor yields unique haptic sensations, such as a hot, rough texture when the player in the game picks up a piece of lava rock, or a cool, smooth sensation when the player touches ice.

Now refer to FIG. 9, illustrating a 3D displacement map 900 in the form of a hand in which, in addition to temperature and texture haptics, data may be conveyed indicating rigidity or resistance, e.g. how “hard” or “soft” or “pliable” a texture feels when pressed. In an example implementation, this may be encoded in the data format with a per-voxel scale from zero to one, where zero means there is no resistance to the voxel being compressed from its starting height and one means there is complete resistance to the voxel being compressed.

Thus, each pin 902 can be a voxel. The texture map in the shape of a hand indicates how far up each pin needed to be raised in order to make the shape and contours of a hand appear. The color-coded temperature map portion controls the temperature of each pin, so that the palm feels warm and the fingertips feel cold. Moreover, each pin 902 may be associated with a hardness metric such as the zero-to-one metric above to indicate how hard it is to the touch.

Thus, if the texture map represents a marble hand, the resistance values of the voxels may be set to maximum (in this example, to one). In contrast, for a balloon in the shape of a hand the resistance values of the voxels may be set to 0.5 since a balloon has some “give”, whereas a resistance value of zero would result in completely flattening the pins upon contact. It is to be appreciated that some voxels may have some resistance values and others may have different resistance values so that resistance, like temperature and texture, can vary over the surface of the controller and hence be spatially-dependent.

Another optional dimension of the data format is time. The heatmap colors and voxel heights may be delivered in a time-based sequence such as a data stream over a web socket. This allows the texture and temperature to change over time as the player interacts with the game.

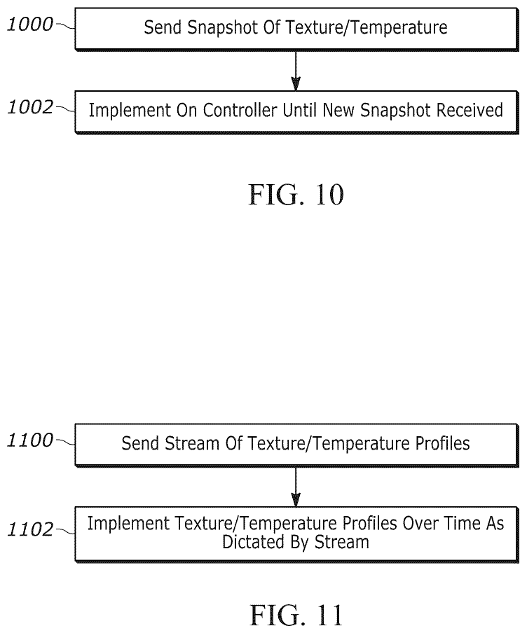

State 1000 in FIG. 10 illustrates that a simple snapshot of voxel and heatmap data is sent to the controller for implementation at state 1002 as the controller changes its texture and temperature to match the received data, maintaining those characteristics until a new snapshot is sent. This minimizes the amount of unnecessary data being sent. However, when the texture and/or temperature needs to change over time, FIG. 11 illustrates that at state 1100 a stream of texture/temperature (and if desired hardness) profiles is sent over time for implementing the profiles on the controller at state 1102.

Present principles contemplate game developer tools consistent with disclosure herein. For game developers to implement texture and temperature changes, tools are provided allowing developers to create the displacement and heatmaps, and to map them over time to events or objects in the game. There are a number of embodiments of such tools.

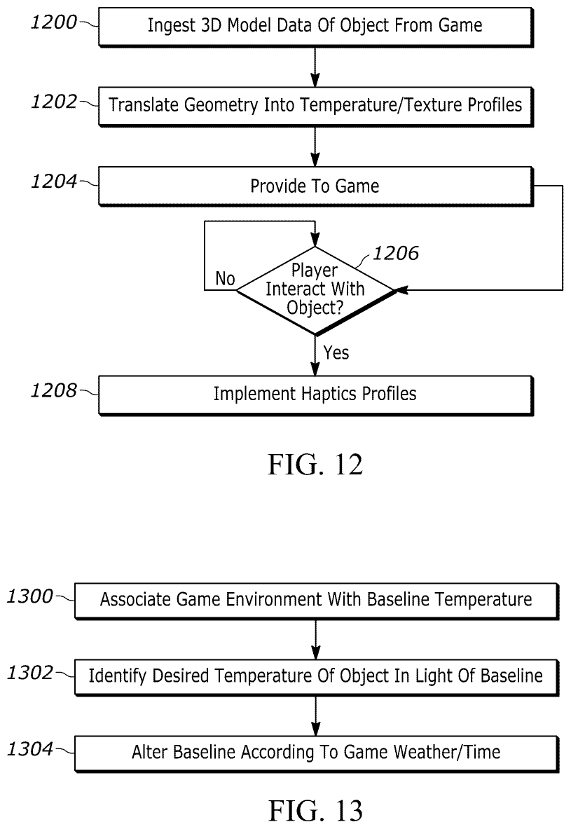

Commencing at state 1200 in FIG. 12, 3D model data of an object from a computer simulation such as a computer is ingested (accessed). Proceeding to state 1202, the geometry of the object is translated into texture and temperature profiles and provided to a game engine at state 1204. Note that certain materials can automatically convert to specific texture/temperature/resistance profiles as indicated by metadata of the associated object, e.g., hot metal, cold ice, crunchy snow, warm sand, hard rock, soft clay, etc.

Proceeding to state 1206, responsive to determining that a player interacts with one of the objects in-game, the texture and temperature data can be automatically sent to the controller and implemented at state 1208.

FIG. 13 illustrates a technique for associating an environment with temperature data to create a baseline temperature at state 1300. At state 1302, a temperature of an object is determined in light of the baseline. For example, a snowy tundra can result in implementing a cold temperature of the controller feel cold by default, and encountering something “warm” might only warm the controller by a few degrees above the cold baseline, which still might feel objectively “cold” despite technically being warmer than the baseline. In contrast, a hot desert might make the controller feel warm by default. Touching something “warm” in that context might not change the controller temperature at all, because the environment is already warmer than the object.

State 1304 of FIG. 13 indicates that the baseline may be altered according to weather and time in the game. For example, if there is a sun in the scene, increasing the intensity of the sun may increase the heat in the scene. Likewise, if there is snow falling in the scene, increasing the amount of snowfall may decrease the heat (increase the cold) in the scene.

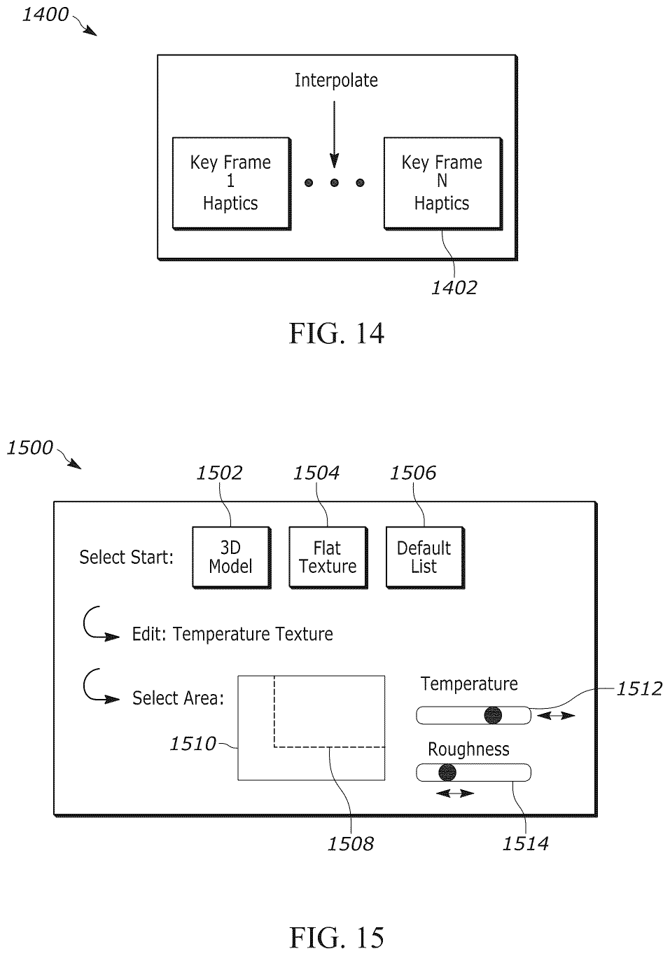

FIG. 14 illustrates a timeline interface 1400 that allows developers to implement a change of texture and/or temperature over time. The interface 1400 allows developers to set up keyframes 1402 containing spatially-dependent texture and temperature (and if desired hardness) profiles, with the software interpolating the changes in texture or temperature between the keyframes.

FIG. 15 illustrates a texture editor 1500 that can, according to developer selection, ingest a texture map 1502 from a 3D model as a starting point, or can start with a flat texture 1504 that can be sculpted using a variety of digital sculpting tools, or start with one of plural default textures 1506 which can be loaded and then customized. Fine-grained editing of voxels from the initial map can be facilitated by allowing the developer to select an area 1508 of the map 1510, then adjust the height of the voxels with respective temperature and texture sliders 1512, 1514. Other adjustment tools such as dials, mathematical functions (wave functions, step functions, etc.) may be used.

Thus, the developer can select an area of a temperature map, then dial the heat up or down, along with transitions and gradients between hotter and cooler areas. For example, a series of hard-edged “hot spots” versus a smooth transition from warm on one side of the controller to cool on the other may be implemented. Also, a visualization tool which allows developers to visualize the changes in temperature, texture, and resistance may be provided, and may be implemented in visual form on a display as any of the displacement maps combined with a heat map shown herein. As developers change various settings to “sculpt” the correct texture and temperature, the visualization tool displays how the changes manifest on the controller. The visualization may take the shape of the controller itself, so developers can see exactly where on the controller the changes will be manifested. When combined with a timeline, the developer can “play back” the changes in haptics, to watch how the textures and temperature change over time.

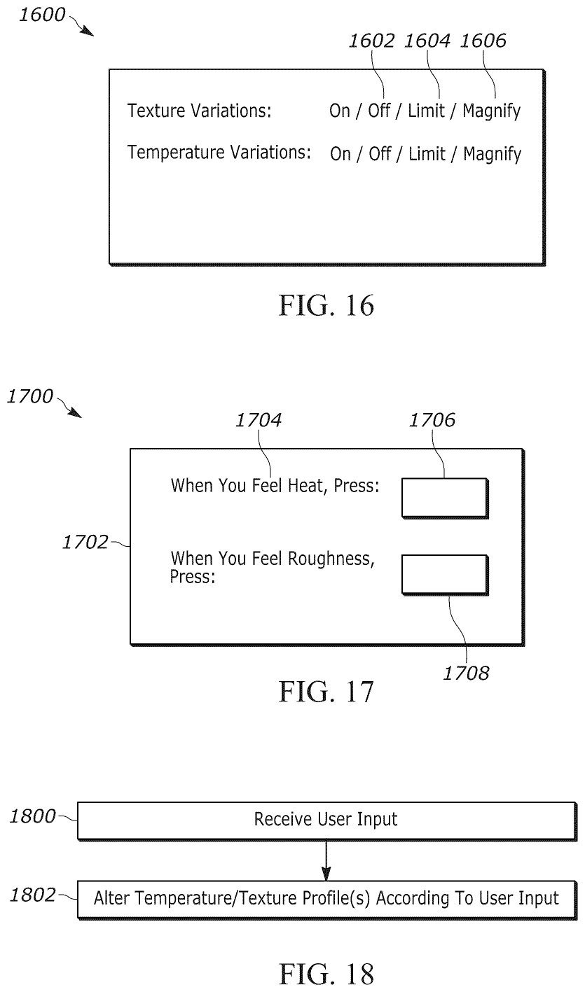

As also understood herein, some people may experience texture and temperature variations differently than others. Accordingly, FIG. 16 illustrates an editor 1600 to increase or decrease variations based on accessibility needs of a user. For example, in FIG. 16 “off” selectors 1602 are provided for each of temperature and texture haptics to prevent temperature and texture variations altogether. Also, anticipating a user who may be overly sensitive to texture and/or temperature, a limit selector 1604 may be used to set thresholds for temperature and texture variations to ensure the controller remains comfortable to use, e.g. it doesn't get too hot or too cold, or the voxel height remains below a certain value.

Continuing with the description of FIG. 16, magnify selectors 1606 for temperature and texture may be provided so that users who have limited sensitivity to texture and/or temperature can increase the thresholds of the relevant haptics to ensure the user can feel the haptics to the best of his or her ability, e.g. temperature or voxel height is increased or decreased by a proportional amount.

FIG. 17 illustrates a temperature and texture sensitivity configuration interface 1700. The interface 1700 in the example shown can present a neutral temperature or texture on a surface 1702, and then instruct the user at 1704 to press a button 1706 once the user detects a change in heat or cold. Similarly, the user may be prompted to press a button 1708 to indicate feeling a change of texture. This establishes a per-user baseline to which future temperature and texture changes may be keyed, e.g., demanded heat for a hot object might not be implemented in the case of a hot-handed person, or may be implemented with a lesser temperature rise than demanded for a cold-handed person.

FIG. 18 illustrates that the input from FIG. 17 as an example is received at state 1800. Moving to state 1802, the temperature and/or texture profile received in the haptics data structure may be altered by the controller for implementing a modified version of the profile as demanded by the user input.

While the particular embodiments are herein shown and described in detail, it is to be understood that the subject matter which is encompassed by the present invention is limited only by the claims.

What is claimed is:

1. A method comprising:
receiving at a device a data structure comprising spatially-dependent texture information; and
changing a texture of a first surface of the device according to the spatially-dependent texture information such that the first surface has a first texture and a second surface of the device has a second texture at a first time.

2. The method of claim 1, wherein the data structure comprises spatially-dependent temperature information, and the method comprises:
changing a temperature of the first surface of the device according to the spatially-dependent temperature information such that the first surface has a first temperature and a second surface of the device has a second temperature at the first time.

3. The method of claim 1, wherein the data structure comprises spatially-dependent hardness information, and the method comprises:
changing a hardness of the first surface of the device according to the spatially-dependent hardness information such that the first surface has a first hardness and a second surface of the device has a second hardness at the first time.

4. The method of claim 1, wherein the device comprises a computer game controller.

5. The method of claim 1, wherein the data structure comprises a three dimensional (3D) displacement map.

6. The method of claim 5, wherein the 3D displacement map comprises voxels representing texture information.

7. The method of claim 6, wherein the 3D displacement map comprises a heat map associated with the voxels and representing temperature information.

8. The method of claim 6, wherein the 3D displacement map comprises, for at least some of the voxels, respective harness indices representing hardness.

9. The method of claim 1, comprising providing time-varying texture information to the device in combination with the data structure comprising spatially-dependent texture information.

10. A processor system configured to:
access three dimensional (3D) model data of an object from a computer simulation, the 3D model data representing a geometry;
translate the geometry into texture and temperature profiles; and
provide the profiles to at least one computer simulation system for implementing the profiles on at least one computer simulation controller responsive to a player interacting with the object in the computer simulation.

11. The processor system of claim 10, comprising the at least one computer simulation system for implementing the profiles on the at least one computer simulation controller.

12. A device comprising:
at least one computer memory that is not a transitory signal and that includes instructions executable by at least one processor system to:
receive spatially-dependent texture information; and
implement the spatially-dependent texture information on a surface of at least one computer simulation controller during play of a computer simulation using the computer simulation controller.

13. The device of claim 12, wherein the spatially-dependent texture information is also time-dependent.

14. The device of claim 12, wherein the instructions are executable to:
receive spatially-dependent temperature information in the texture information; and
implement the spatially-dependent temperature information on the computer simulation controller during play of the computer simulation using the computer simulation controller.

15. The device of claim 12, wherein the instructions are executable to:
receive spatially-dependent hardness information in the texture information; and
implement the spatially-dependent hardness information on the computer simulation controller during play of the computer simulation using the computer simulation controller.

16. The device of claim 12, wherein the texture information is received in a three dimensional (3D) displacement map.

17. The device of claim 16, wherein the 3D displacement map comprises voxels representing texture information.

18. The device of claim 17, wherein the 3D displacement map comprises a heat map associated with the voxels and representing temperature information.

19. The device of claim 17, wherein the 3D displacement map comprises, for at least some of the voxels, respective harness indices representing hardness.

20. The device of claim 12, comprising the at least one processor system.
